(19) United States
(12) Patent Application Publication
(10) Pub. No.: US 2008/0289535 A1
(43) Pub. Date: Nov. 27, 2008

(54) Global Warming Shirt

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 11/755,351

(22) Filed: May 30, 2007

Related U.S. Application Data
(60) Provisional application No. 60/939,629, filed on May 23, 2007.

(51) Int. Cl. C09D 11/00; A41D 27/00; B05D 1/00

(52) U.S. Cl. 106/31.13; 2/1; 427/401

(57) ABSTRACT

Provided are articles and methods for creating articles which include a representation of a planet which undergoes a morphing, or changing in color and pattern, upon application of heat, light or moisture to illustrate the effects of global warming. The article can be any article, including but not limited to clothing and pictures.

### RELATED U.S. APPLICATION DATA

This application claims the benefit of priority under 35 U.S.C. §119(e) to U.S. Provisional Application Ser. No. 60/939,629, filed May 23, 2007, the disclosure of which is hereby incorporated herein by reference thereto.

### TECHNICAL FIELD

This invention relates generally to articles, and methods of making articles, having an image of a planet, or part of a planet, generated with a thermochromic substance. The thermochromic substance will change color upon changes in temperature, light or moisture, thereby changing the image to an image which would be representative of what the planet, or part of the planet, will look like as a result of global warming.

### BACKGROUND

Global warming is a problem we will all have to face in the future. There is much concern over this phenomena, and much uncertainty over how to approach it or whether it is even really a problem. The reality is that global warming is a real threat to all of us, and that global warming will get worse before it gets better.

It is important that this issue be debated and dealt with so that we do not start dealing with it when it is too late. Accordingly, global warming is a critical issue to all of us, and there is a need for innovative approaches to publicize and address the issues raised by global warming.

### SUMMARY OF THE INVENTION

One or more aspects of the invention pertain to an article comprising a representation of a planet, or portion thereof. The planet has one or more areas defined with one or more color changing substances. The color changing substances change color with changes in temperature, light or moisture, thereby providing a representation of the planet, or portion thereof, with the effects of global warming evident.

In additional aspects of the invention, more than one color changing substance is used. These change color at different rates or at different temperatures. In various embodiments, the color changing substance is an ink or material with liquid crystals embedded. In further embodiments, the article can be a piece of apparel, such as a t-shirt, or a picture.

In still other aspects of the invention, the planet represented is Mercury, Venus, Earth, Mars, Jupiter, Saturn, Uranus or Neptune. Instead of a full planet, a portion of a planet is represented in various embodiments. The portion can be North America, South America, Asia, Africa, Europe, Australia, Antarctica, the Arctic, land masses, oceans, seas, hemispheres, etc.

Further aspects of the invention describe a method of making an article comprising the steps of creating a representation of a planet, or portion thereof, on the article, defining areas of the planet with one or more color changing substances. The color changing substances change color with changes in temperature, light or moisture, to indicate the effects of global warming.

### BRIEF DESCRIPTION OF THE DRAWINGS

FIG. 1 shows an article of clothing with a representation of a planet thereon to represent effects of global warming in accordance with one aspect of the present invention.

FIG. 2 shows an article of clothing with a representation of a portion of a planet thereon to represent effects of global warming in accordance with another aspect of the present invention

FIG. 3 shows a picture with a portion of a planet thereon to illustrate effects of global warming in accordance with a further aspect of the present invention.

### DETAILED DESCRIPTION OF THE INVENTION

In accordance with an aspect of the present invention, an article with a representation of a planet, or a portion of a planet, is provided. Methods of making the article are also provided. The representation of the planet or portions thereof have one or more areas which are defined with one or more color changing substances. The color changing substance changes color in accordance with changes in temperature, light or moisture. The color change on the article alters the representation of the planet to illustrate changes related to the effects of global warming. This will publicize the issue of global warming.

The representation can be provided on any type of article. In one embodiment, the article is a piece of clothing. Any type of clothing can be used, including but not limited to T-shirts, shirts, pants, jackets or anything worn. In other embodiments of the present invention, the article can be a picture, such as a picture that is hung on a wall or a picture that is carried by an individual. In further embodiments of the present invention, other types of articles capable of carrying the color changing substance can be used.

In accordance with other aspects of the invention, methods of making an article which includes the creation of a representation of a planet, or portion thereof, on the article are provided. Areas of the planet, or portion thereof, are defined using one or more color changing substance. The color changing substances will change color with temperature, light or moisture changing the planetary representation. The change can be used to show the effects of global warming on the representation.

In other aspects of the invention, more than one color changing substance is provided on the article. Additional embodiments have color changing substances which change at different rates or at different temperatures so that different areas on the planet change at different rates to show the differing effects of global warming on different parts of a planet.

The color changing substance can be made of many different types of materials. For example, ink, paint, cholesteric liquid crystals, plastics, polymers, microencapsulated liquid crystals can be used. Ink is used to create offset images on paper or on fabrics like cotton shirts. Plastics and polymeric materials exhibiting thermochromic properties can be employed to create, for example, a model of a planet. In accordance with the present invention, these materials are applied to the article in appropriate areas, such as a land mass. The use of cholesteric liquid crystals has been disclosed in U.S. Pat. No. 4,642,250, the disclosure of which is incorporated herein by reference. Articles of clothing that change color or patterns when wet are also disclosed in May (U.S. Pat. No. 5,435,010). Kimura (U.S. Pat. No. 4,725,462) teaches articles containing a hidden message or indicia. The indicia is not visible under ambient conditions but becomes so at elevated temperatures. The disclosure of these patents is incorporated by reference herein.

In accordance with other aspects of the present invention, the color changing substance is sensitive to temperature, moisture or light. Thus, the substance changes colors according to changes in these parameters. When temperature change is used, the hotter areas of the planet will preferably change to brighter colors as the temperature increases. It is also contemplated that the hotter areas of a planet will change to brighter colors faster than cooler areas of the planet. Similarly, when light change is used, the hotter areas of the planet will preferably change to brighter colors as the light intensity increases or with changes in the wavelength. As mentioned before, it is also contemplated that the hotter areas of a planet will change to brighter colors faster than cooler areas of the planet.

In additional embodiments of the invention, the article can be, for example, clothing, canvas, paper, metal, plastic, etc.

In other embodiments of the invention, the planet is either Mercury, Venus, Earth, Mars, Jupiter, Saturn, Uranus, Neptune, or a combination thereof. Since we live on Earth, the Earth is the preferred planet to illustrate.

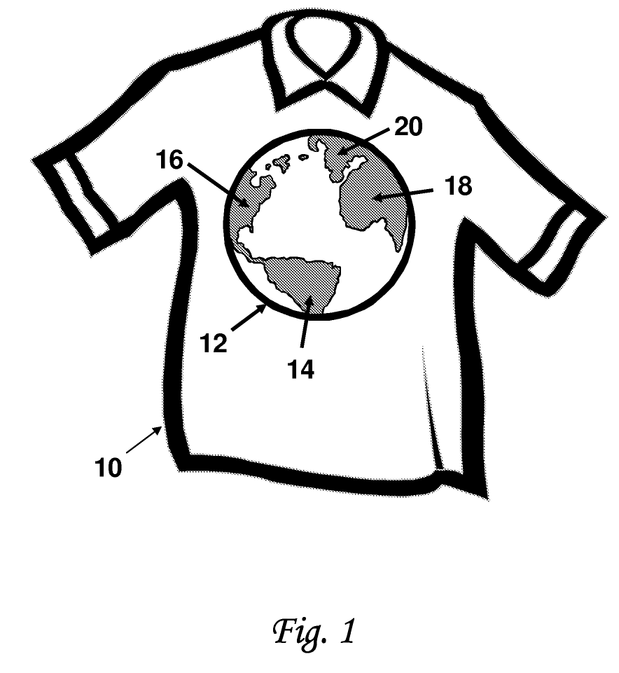

FIG. 1 shows an article of clothing 10 displaying a representation of the planet Earth 12. In other aspects of the invention, only parts of the planet are shown. For example, North America, South America, Africa, Asia, Europe, Australia, Antarctica, or the Arctic Circle can all be represented individually or in combination with each other on the article. In still further embodiments, the planet can be a land mass, a sea, an ocean, a glacier, a mountain, a hemisphere, etc.

Referring to FIG. 1, South America 14, North America 16, Africa 18 and Europe 20 are shown. Each of these areas can be filled in with a color changing substance. If a temperature sensitive substance is used to fill in the areas 14, 16, 18 and 20, then as temperature rises, the areas 14, 16, 18 and 20 would change colors.

It is also possible to fill in the different areas 14, 16, 18 and 20 with different color changing substances so that each area changes color at a different rate. So, by way of example only, area 14 could be created from a first color changing substance, areas 16 and 18 could be created from a second color changing substance and area 20 could be created from a third color changing substance. Since area 14 is generally already hotter than areas 16, 18 and 20, the color changing substance in area 14 would be selected to become brighter faster than the color changing substances in areas 16, 18 and 20, thereby indicating the more severe impact of global warming on area 14. Similarly, since areas 16 and 18 are hotter than area 20, the color changing substances in areas 16 and 18 are selected to become brighter than the color changing substance in area 20. This will reflect the effects of global warming on our planet.

As previously mentioned, the color changing substance can be sensitive to light changes and to moisture changes. As just described, different light sensitive or moisture sensitive color changing substances can be used in different areas to demonstrate the effects of global warming.

In accordance with another aspect of the present invention, the outer areas of the land mass can be filled in with ink or another substance that becomes invisible or that fades or that changes color to match the color of the seas as temperature increases. This will illustrate the rising of the seas and the loss of land mass (and ice formations) as global warming effects take place. As mentioned before, color changing substances that are sensitive to light and moisture can also be used.

A disappearing image on a printable surface is disclosed in Castellanos (U.S. Pat. No. 6,651,551). The disappearing image is made of disappearing ink, and fades from view upon application of heat to the surface of the material. Castellanos also discloses the appearance of an invisible image upon application of heat. The disclosure of Castellanos can be used to implement the disappearing or fading areas on the outside of land masses, and is incorporated by reference herein.

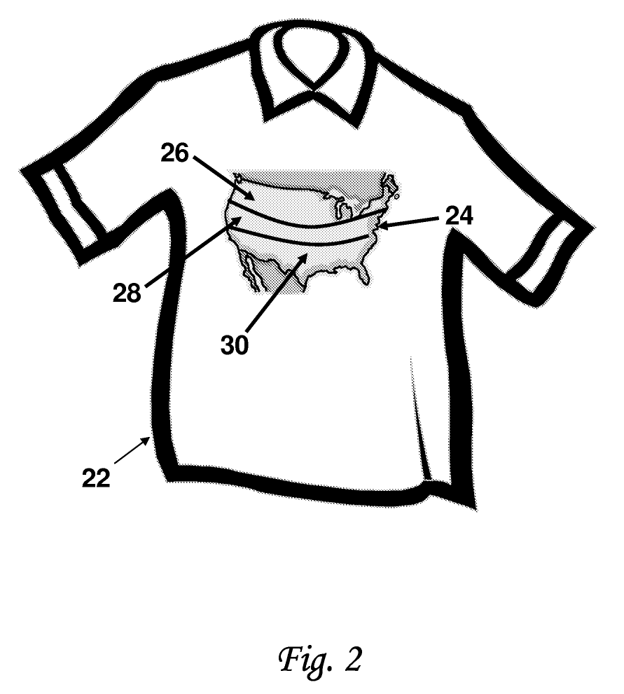

As previously mentioned, the entire planet does not need to be illustrated. By way of example, FIG. 2 shows an article of clothing 22 displaying a representation of the United States 24. The United States 24 can be created from a single color changing substance. In this case, however, the United States 24 is divided into three bands 26, 28 and 30. The bands 26, 28 and 30 generally related to temperature zones found in the United States. Each of these bands 26, 28 and 30 can be formed with a different color changing substance so that they change colors at different rates. Thus, zone 30 would become brighter faster than zones 26 and 28 as temperature rises, light intensity increases, wavelengths change or moisture levels increase. Similarly, zone 28 would become brighter than zone 26 under the same parameters.

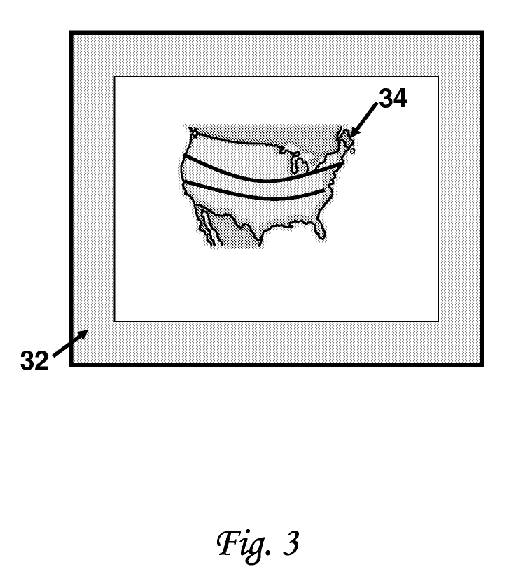

FIG. 3 illustrates a picture 32 having the representation of the United States 34 in accordance with the present invention. All of the previously discussed aspects of the present invention can be used on the picture, or on any other article.

The term “planet” used in this specification and the appended claims means any portion of a planet. For example, “planet” can refer to a continent, country, ocean, sea, land mass, hemisphere, etc.

Although the invention herein has been described with reference to particular embodiments and aspects, it is to be understood that these embodiments and aspects are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. An article comprising:
a representation of a planet, or portion thereof, being located on the article; and
the planet having one or more areas defined with one or more color changing substances;
wherein the one or more color changing substances change color to indicate effects of global warming.

2. The article of claim 1 wherein the one or more color changing substances change color with changes in one or more of temperature, light or moisture.

3. The article of claim 1 wherein the one or more defined areas each have different color changing substances which change color at different rates.

4. The article of claim 1 wherein the one or more defined areas have different color changing substances which change color with one or more differences in temperature, light or moisture.

5. The article of claim 1 wherein the color changing substance comprises ink.

6. The article of claim 1 wherein the article is clothing.

7. The article of claim 1 wherein the article is a picture.

8. The article of claim 1 wherein the planet is Earth.

9. The article of claim 1 wherein the portion of the planet comprises North America.

10. The article of claim 1 wherein the planet is selected from the group consisting of Mercury, Venus, Earth, Mars, Jupiter, Saturn, Uranus and Neptune.

11. The article of claim 1 wherein the one or more areas have outer areas that disappear in response to changes in one or more of temperature, light or moisture.

12. The article of claim 1 wherein the one or more areas have outer areas that change color to match a color of areas adjacent to the one or more areas on the article.

13. A method of making an article comprising:
creating a representation of a planet, or portion thereof, on the article; and
defining areas of the planet with one or more color changing substances;
wherein the one or more color changing substances change color with temperature changes to indicate the effects of global warming.

14. The article of claim 13 wherein the one or more color changing substances change color with changes in one or more of temperature, light or moisture.

15. The method of claim 13 wherein the representation of a planet further comprises different color changing substances which change color at different rates.

16. The method of claim 13 wherein the representation of a planet further comprises different color changing substances which change color with differences in one or more of temperature, light or moisture.

17. The method of claim 13 wherein the color changing substance comprises ink.

18. The method of claim 13 wherein the article is clothing.

19. The method of claim 13 wherein the article is a picture.

20. The method of claim 13 wherein the planet is Earth.

21. The method of claim 13 wherein the portion of the planet comprises North America.

22. The method of claim 13 wherein the planet is selected from the group consisting of Mercury, Venus, Earth, Mars, Jupiter, Saturn, Uranus and Neptune.
